(19) United States
(12) Patent Application Publication
(10) Pub. No.: US 2010/0284266 A1
(43) Pub. Date: Nov. 11, 2010

(54) ORTHOGONAL FREQUENCY DIVISION MULTIPLEXING SYSTEM AND METHOD FOR INTER-CELL INTERFERENCE CANCELLATION OF THE ORTHOGONAL FREQUENCY DIVISION MULTIPLEXING SYSTEM

(75) Inventors: Han yong Jang, Seoul (KR); Hyung Won Kim, Seongnam-si (KR)

Correspondence Address: CANTOR COLBURN, LLP, 20 Church Street, 22nd Floor, Hartford, CT, 06103, US

(73) Assignee: XRONET CORPORATION, Seongnam-si (KR)

(21) Appl. No.: 12/810,941

(22) PCT Filed: Dec. 12, 2008
(86) PCT No.: PCT/KR08/07359

§ 371 Date: Jun. 28, 2010

(30) Foreign Application Priority Data
Dec. 29, 2007 (KR) 10-2007-0141146
Apr. 1, 2008 (KR) 10-2008-0030448

(51) Int. Cl. H04W 24/00; H04J 11/00

(52) U.S. Cl. 370/210; 370/252

(57) ABSTRACT

An orthogonal frequency division multiplexing (OFDM) system and an inter-cell interference cancelling method performed in the OFDM system are provided. The OFDM system includes a Fourier transformer which transforms a received base band signal into a pilot subcarrier signal and a data subcarrier signal, a Doppler/delay spread estimator which estimates a coherent time and a coherent bandwidth from the pilot subcarrier signal, a pilot block size selector which selects a pilot block including at least one pilot signal, based on the coherent time and the coherent bandwidth, a simultaneous channel estimator which estimates a channel response signal based on the at least one pilot signal located in the pilot block, and a simultaneous symbol extractor which extracts a data symbol from the data subcarrier signal on the basis of the channel response signal.

### TECHNICAL FIELD

The present invention relates to an orthogonal frequency division multiplexing (OFDM) or orthogonal frequency division multiple access (OFDMA) system, and more particularly, to an OFDM system for canceling an inter-cell interference by selecting an optimal pilot block, and a method of canceling inter-cell interference.

### BACKGROUND ART

An OFDM system, which is one of wideband wireless communication systems, provides high transmission efficiency, is strong for multi-path fading environments, and is attracting attentions as a wireless connection method of a next-generation wireless communication system. In the OFDM system, to achieve signal transmission between a base station and a terminal, the base station repeatedly transmits encoded data for the sake of terminals located under a bad channel environment, and the terminal estimates a channel response from the base station by using a pilot subcarrier signal received from the base station and receives data using a method of synthesizing repeated data subcarrier signals by using the channel response.

However, in the OFDM system, a terminal located at a cell boundary is unable to receive accurate data from a base station existing in a cell of the terminal, for example, a service base station, because of interference of other cells, namely, interference of the base stations of the other cells.

For example, if a terminal, for example, a mobile phone, is located at a cell boundary as illustrated in FIG. 1, the mobile phone receives not only a signal from a service base station which receives services, for example, a first base station, but also signals from adjacent base stations, for example, second, third, and fourth base stations. This results in severe signal interference. Thus, an OFDM system and method capable of canceling interference signals from neighboring base stations is demanded.

### DISCLOSURE OF INVENTION

### Technical Problem

The present invention provides an orthogonal frequency division multiplexing (OFDM) system for canceling an interference signal by selecting an optimal pilot block. The present invention also provides a method of canceling inter-cell interference by using the OFDM system.

### ADVANTAGEOUS EFFECTS

In an OFDM system and an inter-cell interference cancelling method performed in the OFDM system, an optimal pilot block is selected using the fact that a variation in the frequency domain is greater than a variation in the time domain, a channel response signal is estimated from the selected pilot block, and interference-cancelled data symbols are extracted from the channel response signal. Therefore, the reception performance of the OFDM system improves, and thus the capacity of the OFDM system may be increased.

### BRIEF DESCRIPTION OF DRAWINGS

The above and other features and advantages of the present invention will become more apparent by describing in detail exemplary embodiments thereof with reference to the attached drawings in which:

FIG. 1 illustrates inter-cell interference in a conventional orthogonal frequency division multiplexing (OFDM) system;

FIG. 2 is a schematic block diagram of an OFDM system according to an embodiment of the present invention;

FIG. 3 is a flowchart illustrating an operation of the OFDM system illustrated in FIG. 2;

FIG. 4 illustrates a schematic structure of pilot blocks according to an embodiment of the present invention; and

FIG. 5 is a graph showing the performance of an OFDM system when the pilot block illustrated in FIG. 4 is used.

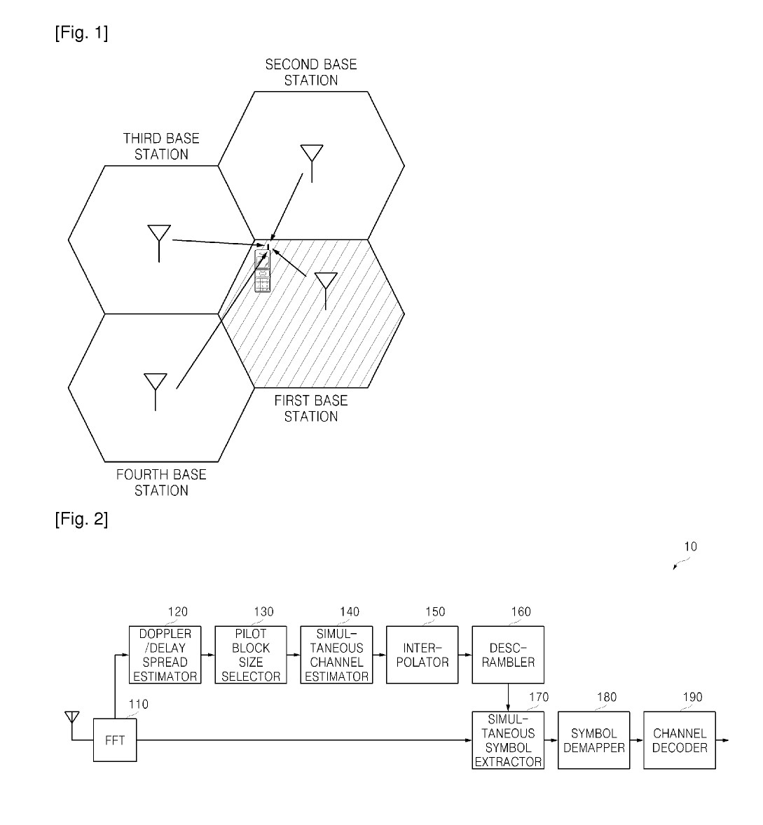

### BEST MODE FOR CARRYING OUT THE INVENTION

According to an aspect of the present invention, there is provided an orthogonal frequency division multiplexing (OFDM) system including a Fourier transformer which transforms a received base band signal into a pilot subcarrier signal and a data subcarrier signal, a Doppler/delay spread estimator which estimates a coherent time and a coherent bandwidth from the pilot subcarrier signal, a pilot block size selector which selects a pilot block including at least one pilot signal, based on the coherent time and the coherent bandwidth, a simultaneous channel estimator which estimates a channel response signal based on the at least one pilot signal located in the pilot block, and a simultaneous symbol extractor which extracts a data symbol from the data subcarrier signal on the basis of the channel response signal.

According to another aspect of the present invention, there is provided an inter-cell interference cancelling method performed in the OFDM system, the inter-cell interference cancelling method including receiving a scrambled base band signal from each of a service base station and neighboring base stations via an antenna; extracting a pilot subcarrier signal and a data subcarrier signal from the scrambled base band signal and estimating a coherent time and a coherent bandwidth from the pilot subcarrier signal; selecting a pilot block including at least one pilot signal, based on the coherent time and the coherent bandwidth; estimating a channel response signal based on the at least one pilot signal located in the pilot block; and extracting a data symbol from the data subcarrier signal on the basis of the channel response signal.

### MODE FOR THE INVENTION

The attached drawings for illustrating preferred embodiments of the present invention are referred to in order to gain a sufficient understanding of the present invention, the merits thereof, and the objectives accomplished by the implementation of the present invention. It will be understood that when an element is said to be “transmitting” data to another element, the element can directly transmit the data to another element or transmit the data to another element via at least one other element. In contrast, when an element is said to be “directly transmitting” data to another element, the element transmits the data to another element without passing through any other element.

Hereinafter, the present invention will be described in detail by explaining preferred embodiments of the invention with reference to the attached drawings. Like reference numerals in the drawings denote like elements.

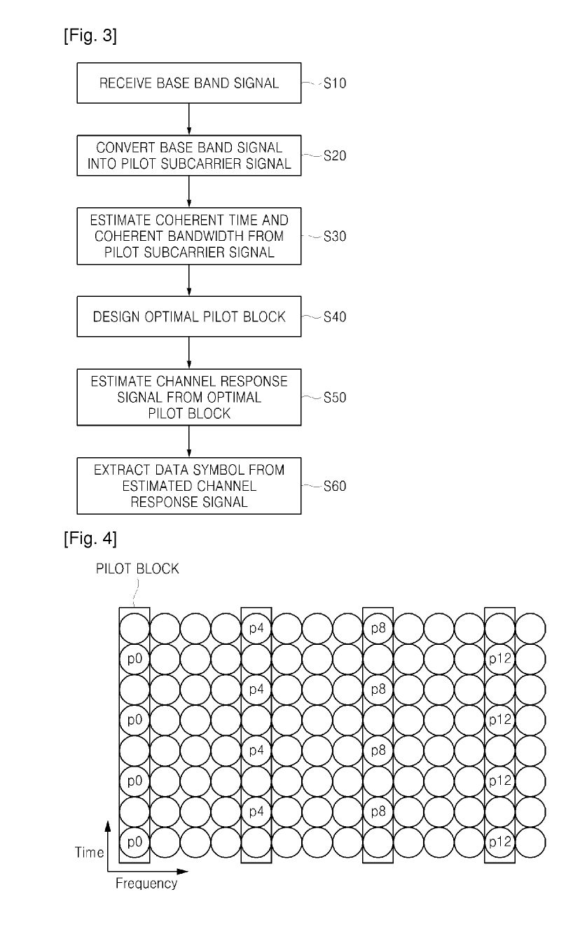

FIG. 2 is a schematic block diagram of an OFDM system 10 according to an embodiment of the present invention. FIG. 3 is a flowchart illustrating an operation of the OFDM system 10 illustrated in FIG. 2.

Referring to FIG. 2, the OFDM system 10 may include a fast Fourier transformer (FFT) 110, a Doppler/delay spread estimator 120, a pilot block size selector 130, a simultaneous channel estimator 140, an interpolator 150, a descrambler 160, a simultaneous symbol extractor 170, a symbol demapper 180, and a channel decoder 190.

The FFT 110 transforms a base band signal in a time domain received via a reception antenna into a signal in a frequency domain. The base band signal includes interference signals transmitted from interfering base stations other than a service base station. For example, the transmitted base band signal may include a plurality of signals scrambled according to unique scrambling codes of base stations.

The FFT 110 transmits a pilot subcarrier signal included in the signal in the frequency domain to the Doppler/delay spread estimator 120 and transmits a data subcarrier signal included in the signal in the frequency domain to the simultaneous symbol extractor 170. The Doppler/delay spread estimator 120 estimates a coherent time Tc and a coherent frequency Bc, for example, a correlation bandwidth, from the pilot subcarrier signal.

The pilot block size selector 130 selects a pilot block including at least one pilot signal on the basis of the coherent time Tc and the coherent bandwidth Bc estimated by the Doppler/delay spread estimator 120. The simultaneous channel estimator 140 estimates a channel response signal from the selected pilot block. The simultaneous channel estimator 140 may estimate the channel response signal from the pilot block by using an approximate inverse matrix, on the basis of a predetermined condition, for example, a condition that the total number of pilot signals located in the single selected pilot block should be substantially equal to or greater than the number of base stations.

The interpolator 150 interpolates the estimated channel response signal in order to extract a channel response signal on a time/frequency axis. The channel response signal extracted by the interpolator 150 may include channel response signals of all data subcarrier signals. The descrambler 160 descrambles and outputs the channel response signal extracted by the interpolator 150.

The simultaneous symbol extractor 170 extracts an interference-cancelled data symbol for each base station on the basis of the channel response signals of all data subcarrier signals obtained by the descrambling performed in the descrambler 160 and the data subcarrier signal received from the FFT 110. The symbol demapper 180 converts the data symbol for each base station into a bit signal and outputs the bit signal to the channel decoder 190. The channel decoder 190 decodes the bit signal into a data signal.

An operation of the OFDM system 10 will now be described with reference to FIGS. 2 and 3. When the base band signal is received via the reception antenna in operation S10, the FFT 110 converts the base band signal into the pilot subcarrier signal, in operation S20. In operation S30, the pilot subcarrier signal is input to the Doppler/delay spread estimator 120, and the Doppler/delay spread estimator 120 estimates the coherent time Tc and the coherent bandwidth Bc from the pilot subcarrier signal.

A phenomenon in which a frequency is shifted according to the speed of a moving body is called a Doppler shift, and a frequency shift distribution is called Doppler spread. For example, the time-varying characteristic of a channel due to a relative motion between a base station and a terminal may be represented as Doppler spread or the coherent time Tc calculated using Equation 1:

T_{c}=1/fₘ (1)

wherein fₘ denotes a maximum Doppler shift. The maximum Doppler shift may be represented as in

fₘ=ν/λ

If a correlation in the time domain is about 0.5, the coherent time Tc may be expressed as in Equation 2:

$${T}_{c} \approx \frac{1}{2 {f}_{m}} \qquad ( 2 )$$

Delay spread represents a channel characteristic in the time domain due to multiple paths. In other words, the frequency band of a channel may be represented by a coherent bandwidth. The delay spread and the coherent bandwidth are inversely proportional to each other. In other words, the coherent bandwidth may represent the statistical range of a frequency band which has frequency components with substantially identical gains and has a linear phase. For example, if two signals having adjacent frequency components are transmitted, the frequencies of the two signals are very close to each other, and thus decrements of the frequencies after the frequencies pass through a channel are very similar. If a correlation in the time domain is about 0.5, the coherent bandwidth Bc may be expressed as in Equation 3:

B_{c}=1/Tₘ (3)

where Tm denotes a Root Mean Square (RMS) delay spread value. As described above, the coherent time Tc and the coherent bandwidth Bc estimated by the Doppler/delay spread estimator 120 are provided to the pilot block size selector 130.

In operation S40, the pilot block size selector 130 designs an optimal pilot block based on the coherent time Tc and the coherent bandwidth Bc. The designed optimal pilot block may include at least one pilot signal, and the pilot block size selector 130 selects and outputs the designed optimal pilot block. For example, when considering a coherent bandwidth and a coherent time on channel changes in the frequency domain and the time domain, a time variation in the time domain is smaller than that in the frequency domain.

The pilot block size selector 130 may select an optimal pilot block in the time domain by considering the coherent time Tc and the coherent bandwidth Bc in order to achieve simultaneous channel response estimation which will be described later. For example, a pilot block may be designed so as to satisfy the condition of Inequality 4:

Pilot block≦Bc, or pilot block≦Tc (4)

As expressed in Inequality 4, the pilot block may be designed so as to be less than or equal to the coherent bandwidth Bc or less than or equal to the coherent time Tc. However, more preferably, the pilot block may be designed so as to be substantially less than the coherent bandwidth Bc or the coherent time Tc.

In operation S50, the simultaneous channel estimator 140 estimates the channel response signal from the optimal pilot block selected by the pilot block size selector 130. The simultaneous channel estimator 140 may extract the total number of pilot signals from the pilot block and estimate a simultaneous channel response signal based on the total number of pilot signals. For example, if Np denotes the number of available pilot signals included in each block and K denotes the total number of service base stations and neighboring base stations, Np pilot signals P located in a single pilot block of a K-th base station may be expressed as in Equation 5:

p^{(k)}=(p^{(k,0)} . . . p^{(k,N}^{ₚ}⁻¹⁾)^{T}, k=0, . . . , K−1 (5)

A channel response signal h corresponding to Equation 5 may be expressed as Equation 6:

h^{(k)}=(h^{(k,0)} . . . h^{(k,N}^{ₚ}⁻¹⁾)^{T}, k=0, . . . , K−1 (6)

Interfering signals N from neighboring base stations may be expressed as Equation 7:

N=(n⁽⁰⁾ . . . n^{(N}^{ₚ}⁻¹⁾) (7)

The total number of pilot signals included in a pilot signal may be calculated using Equation 8, which is based on Equations 5, 6, and 7;

R=PH+N

(8) where P denotes the pilot signal, H denotes a channel response signal, R denotes a total number of received signals, and N denotes interfering signals from neighboring base stations. Equation 8 may be expressed as a matrix of Equation 9:

$$( \begin{matrix}{R}_{0} \\ {R}_{1} \\ ⋮ \\ {R}_{( NP - 1 )}\end{matrix} ) = ( \begin{matrix}{P}_{0 , 1} & {P}_{0 , 2} & … & {P}_{0 , k} \\ {P}_{1 , 1} & {P}_{1 , 2} & … & {P}_{1 , k} \\ ⋮ & ⋮ & ⋱ & ⋮ \\ {P}_{( NP - 1 ) , 1} & {P}_{( NP - 1 ) , 2} & … & {P}_{( NP - 1 ) , k}\end{matrix} ) ( \begin{matrix}{H}_{0} \\ {H}_{1} \\ ⋮ \\ {H}_{k}\end{matrix} ) + ( \begin{matrix}{N}_{0} \\ {N}_{1} \\ ⋮ \\ {N}_{( NP - 1 )}\end{matrix} ) \qquad ( 9 )$$

Maximum likelihood estimation of a simultaneous channel response signal H from a single pilot block may be achieved according to Equation 10:

\hat{H}=(P^{H}P)⁻¹P^{H}R

(10) where P denotes a pilot signal, H denotes the channel response signal, and R denotes a total number of received signals. Equation 10 is to estimate the corresponding channel response signal by using an approximate inverse matrix of transmitted pilot signals already known from received pilot signals. For example, if the number of interfering base stations is 1(that is, k=1) and a pilot block includes two pilot signals (that is, Np=2), the channel response signal estimation may be expressed as Equation 11, by calculating the approximate inverse matrix from Equation 10:

$${H}_{0} = \frac{{P}_{1 , 2} {R}_{0} - {P}_{0 , 2} {R}_{1}}{{P}_{0 , 1} {P}_{1 , 2} - {P}_{1 , 1} {P}_{0 , 2}} , {H}_{1} = \frac{{P}_{0 , 2} {R}_{0} - {P}_{0 , 1} {R}_{1}}{{P}_{0 , 1} {P}_{1 , 2} - {H}_{1 , 1} {P}_{0 , 2}} \qquad ( 11 )$$

where P denotes a pilot signal, H denotes the channel response signal, and R denotes a total number of received signals. To cope with a channel variation, a small-size pilot block needs to be selected. However, in order for an inverse matrix such as Equation 11 to exist, the total number Np of pilot signals located in a selected pilot block needs to be equal to or greater than the number k of base stations to be interfered. In other words, a condition that Np≧k needs to be satisfied.

In operation S60, the simultaneous symbol extractor 170 extracts the data symbol from the estimated channel response signal. For example, the simultaneous symbol extractor 170 may extract a data symbol received from a corresponding base station by using a synthesis weight W calculated from the estimated channel response signal. In other words, the simultaneous symbol extractor 170 detect not only a data symbol for a service base station but also data symbols for interfering base stations by using the channel response signal estimated based on Equations 9 through 11, as expressed in Equation 12:

$$D = WR \\ ( \begin{matrix}{D}_{0} \\ {D}_{1} \\ ⋮ \\ {D}_{K}\end{matrix} ) = ( \begin{matrix}{W}_{0 , 1} & {W}_{0 , 2} & … & {W}_{0 , R} \\ {W}_{1 , 1} & {W}_{1 , 2} & … & {W}_{1 , R} \\ ⋮ & ⋮ & ⋱ & ⋮ \\ {W}_{K , 1} & {W}_{K , 2} & … & {W}_{K , R}\end{matrix} ) ( \begin{matrix}{Z}_{0} \\ {Z}_{1} \\ ⋮ \\ {Z}_{R}\end{matrix} ) \qquad ( 12 )$$

where D denotes a data symbol detected from each base station, W denotes a weight calculated from the channel response signal, and Z denotes each of repeatedly received data subcarriers. As shown in Equation 12, if the simultaneous symbol extractor 170 desires to detect only the data symbol for the service base station, the data symbol may be calculated using Equation of Dₖ=WₖZ. The weight W may be calculated so as to remove an interfering data symbol from repeated symbols, namely, from repeatedly received data symbols, and thus a data symbol from which interfering signals from interfering base stations have been removed may be extracted according to Equation 12. The extracted data symbol passes through the symbol demapper 180 and the channel decoder 190 and thus turns into a data signal.

FIG. 4 illustrates a schematic structure of pilot blocks according to an embodiment of the present invention. Referring to FIG. 4, four pilot signals P0, P4, P8, and P12 are located in each of the pilot blocks according to the above-described condition, that is, the condition that the total number Np of pilot signals P0, P4, P8, and P12 located in a selected pilot block is equal to or greater than the number k of base stations which are to be interfered. The selected pilot block considers the coherent time Tc and the coherent bandwidth Bc and has a minimum size in order to cope with a channel variation. In other words, since a time variation is smaller than a frequency variation in an OFDM system, it is suitable that a pilot block in which four pilot signals are arrayed in the time axis is selected to estimate a channel response.

FIG. 5 is a graph showing the performance of an OFDM system when the pilot block illustrated in FIG. 4 is used. A pilot block selecting method of an OFDM system according to the present invention can be embodied as computer readable codes on a computer readable recording medium. Also, functional programs, codes, and code segments for accomplishing the present invention can be easily construed by programmers of ordinary skill in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

Embodiments of the present invention are applicable to communication systems, particularly, OFDM systems.

1. An orthogonal frequency division multiplexing (OFDM) system comprising:
a Fourier transformer transforming a received base band signal into a pilot subcarrier signal and a data subcarrier signal;
a Doppler/delay spread estimator estimating a coherent time and a coherent bandwidth from the pilot subcarrier signal;
a pilot block size selector selecting a pilot block including at least one pilot signal, based on the coherent time and the coherent bandwidth;
a simultaneous channel estimator estimating a channel response signal based on the at least one pilot signal located in the pilot block; and
a simultaneous symbol extractor extracting a data symbol from the data subcarrier signal on the basis of the channel response signal.

2. The OFDM system of claim 1, wherein the Doppler estimator estimates the coherent time which satisfies Equation of T_{c}=1/fₘ (where Tc denotes the coherent time and fm denotes a maximum Doppler shift).

3. The OFDM system of claim 1, wherein the delay spread estimator estimates the coherent bandwidth which satisfies Equation of B_{c}=1/Tₘ (where Bc denotes the coherent bandwidth and Tm denotes a RMS delay spread).

4. The OFDM system of claim 2, wherein the pilot block selected by the pilot block size selector is less than or equal to the coherent time and the coherent bandwidth.

5. The OFDM system of claim 1, wherein if the total number of pilot signals located in the selected pilot block is equal to or greater than the total number of base stations which are to be interfered, the simultaneous channel estimator estimates the channel response signal using an approximate inverse matrix.

6. The OFDM system of claim 5, wherein the simultaneous channel estimator estimates the channel response signal which satisfies Equation of Ĥ=(P^{H}P)⁻¹P^{H}R (where P denotes a pilot signal, H denotes the channel response signal, and R denotes a total number of received signals).

7. An inter-cell interference cancelling method performed in an orthogonal frequency division multiplexing (OFDM) system, the inter-cell interference cancelling method comprising:
receiving a scrambled base band signal from each of a service base station and neighboring base stations via an antenna;
extracting a pilot subcarrier signal and a data subcarrier signal from the scrambled base band signal and estimating a coherent time and a coherent bandwidth from the pilot subcarrier signal;
selecting a pilot block including at least one pilot signal, based on the coherent time and the coherent bandwidth;
estimating a channel response signal based on the at least one pilot signal located in the pilot block; and
extracting a data symbol from the data subcarrier signal on the basis of the channel response signal.

8. The inter-cell interference cancelling method of claim 7, wherein in the estimating of the coherent time, the coherent time which satisfies Equation of T_{c}=1/fₘ (where Tc denotes the coherent time and fm denotes a maximum Doppler shift) is estimated.

9. The inter-cell interference cancelling method of claim 7, wherein in the estimating of the coherent bandwidth, the coherent bandwidth which satisfies Equation of B_{c}=1/Tₘ (where Bc denotes the coherent bandwidth and Tm denotes a RMS delay spread) is estimated.

10. The inter-cell interference cancelling method of claim 8, wherein the selecting of the pilot block, the pilot block which is less than or equal to the coherent time and the coherent bandwidth is selected.

11. The inter-cell interference cancelling method of claim 7, wherein in the estimating of the channel response signal, if the total number of pilot signals located in the selected pilot block is equal to or greater than the total number of base stations which are to be interfered, the channel response signal is estimated from the pilot signals included in the pilot block by using an approximate inverse matrix.

12. The inter-cell interference cancelling method of claim 11, wherein in the estimating of the channel response signal, the channel response signal which satisfies Equation of Ĥ=(P^{H}P)⁻¹P^{H}R (where P denotes a pilot signal, H denotes the channel response signal, and R denotes a total number of received signals) is estimated.

13. The OFDM system of claim 4, wherein the pilot block selected by the pilot block size selector is less than or equal to the coherent time and the coherent bandwidth.

14. The inter-cell interference cancelling method of claim 9, wherein the selecting of the pilot block, the pilot block which is less than or equal to the coherent time and the coherent bandwidth is selected.
